(19) United States
(12) Patent Application Publication
(10) Pub. No.: US 2015/0146510 A1
(43) Pub. Date: May 28, 2015

(54) SERVER SYSTEM AND CONTROL METHOD FOR READ/WRITE INDICATOR LIGHT

(71) Applicants: INVENTEC (PUDONG) TECHNOLOGY CORPORATION, Shanghai (CN); INVENTEC CORPORATION, Taipei (TW)

(72) Inventor: Tian-Wen ZHAO, Shanghai (CN)

(73) Assignees: INVENTEC (PUDONG) TECHNOLOGY CORPORATION, Shanghai (CN); INVENTEC CORPORATION, Taipei (TW)

(21) Appl. No.: 14/256,072

(22) Filed: Apr. 18, 2014

(30) Foreign Application Priority Data
Nov. 27, 2013 (CN) 201310636728.9

(51) Int. Cl. G11B 33/10; G06F 3/00

(52) U.S. Cl. CPC G11B 33/10; G06F 3/002
USPC 369/53.44

(57) ABSTRACT

A server system and a control method for a read/write indicator light are disclosed, in which a serial general purpose input/output signal is issued when a read/write action occurs, a bit of effective non-zero data is written into a register when the SGPIO signal has a level change, a content of the register is checked out every predetermined period, and a drive signal is outputted to drive the read/write indicator light to blink when the data in every bit of the register is not all non-zero, whereby achieving in a technical efficacy of promoting recognizability of the read/write indicator light.

### BACKGROUND OF THE RELATED ART

1. Technical Field

The present invention is related to a server system and a control method for a read/write indicator light therefor, and particularly to a server system and a control method for a read/write indicator light therefore, which generates a drive signal according to a level change of a serial general purpose input/output (SGPIO).

2. Related Art

Recently years, with wide prevalence and vigorous development of hard disk technology, the hard disk has a more and more rapid read/write speed. Therefore, the conventional way of driving a read/write indicator light by directly using a read/write signal has become unsatisfactory.

Generally, the read/write indicator light blinks when the hard disk has a read/write occurring. However, in the case where the hard disk has a very rapid read/write speed, human eyes may not recognize if a LED used as the indicator light blinks since a waveform frequency generated by the hard disk when the read/write action occurs may go beyond a response time of the LED, resulting in that the human eyes may not recognize if the LED blinks. Thus, the read/write indicator light has the issue of hard recognizability.

In response to this issue, there is a proposal for replacing the pure LED displaying manner with a waveform representation. However, although a user may realize the current read/write state according to a change of the waveform representation, the hard recognition situation may also impose to the user. Therefore, the above manner still may not effectively overcome the hard recognition issue encountered in the read/write indicator light.

In view of the above, it may be known that there has long been the issue of hard recognition in the read/write indicator light, and thus there is quite a need to set forth an improvement means to settle down this problem.

### SUMMARY

The present invention discloses a server system and a control method for a read/write indicator light.

The server system comprises at least a read/write indicator light; at least a hard disk module, generating a serial general purpose input/output (SGPIO) signal when a read/write operation is executed therein; and an indicator control circuit, comprising a register, having a size of a fixed bits each being set to a zero value at the beginning of every a predetermined period, and being written with a non-zero value to one of the fixed bits when the level of SGPIO signal thereof is changed; and a control unit, checking each of the fixed bits in the register once every predetermined period, and outputting a drive signal to drive the read/write indicator light to blink when any of the bit value is nonzero.

According to the present invention, the control method for a read/write indicator light, comprising steps of issuing a serial general purpose input/output (SGPIO) signal by a hard disk module when a read/write operation is executed in the hard disk module, and receiving an effective non-zero information when the SGPIO signal has a level change occurring; subsequently writing the received effective non-zero information into a register, the register having a fixed bits each having an initial value of zero; checking out a content of the register once every predetermined period, and outputting a drive signal to drive the read/write indicator light to blink when the content is a value other than all zero for all the fixed bits; and driving the read/write indicator light to blink by the driving signal.

The system and method of the present invention has the difference that a serial general purpose input/output signal is issued when a read/write action occurs, a bit of effective non-zero data is written into a register when the SGPIO signal has a level change, a content of the register is checked out every predetermined period, and a drive signal is outputted to drive the read/write indicator light to blink when the data in every bit of the register is not all non-zero.

By using of the above technical means, the technical efficacy of promoting the recognizability of read/write indicator light may be achieved.

### BRIEF DESCRIPTION OF THE DRAWINGS

The invention will become more fully understood from the detailed description given herein below illustration only, and thus is not limitative of the present invention, and wherein:

FIG. 1 is a systematic block diagram of a server system according to the present invention;

FIG. 2 is a flowchart of a control method for a read/write indicator light according to the present invention; and

FIG. 3 is a schematic diagram for illustrating controlling the read/write indicator light by using a drive signal according to the present invention.

### DETAILED DESCRIPTION

The present invention will be apparent from the following detailed description, which proceeds with reference to the accompanying drawings, wherein the same references relate to the same elements.

Prior to the description of a server system and control method of a read/write indicator light of the present invention, an application environment onto which the present invention is used is described first. The present invention is used on an environment having a hard disk with a read/write indicator light in the form of a LED, where the read/write indicator light receives a serial general purpose input/output (SGPIO) signal.

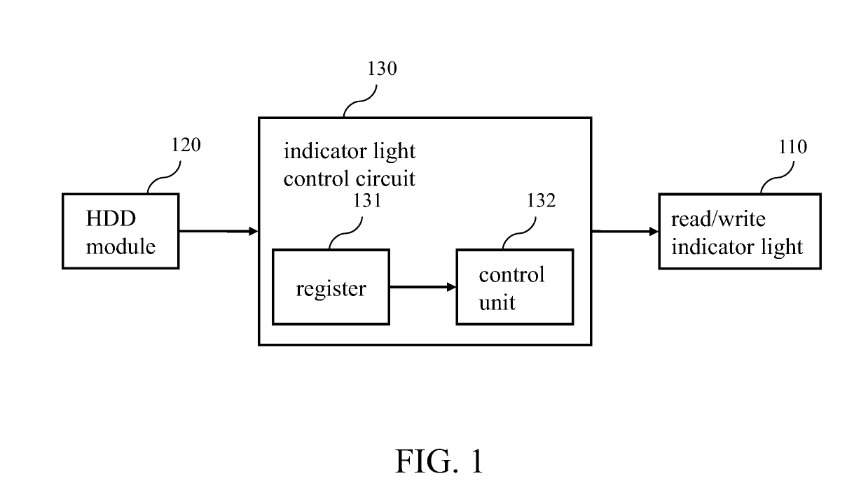

In what follows, the server system and control method for a read/write indicator light according to the present invention will be described with reference to figures. Referring to FIG. 1 now, in which a systematic block diagram of the server system according to the present invention is shown. The system comprises a read/write indicator light 110, a hard disk module 120 and an indicator light control circuit 130. The read/write indicator light is a common display element, such as LED.

The hard disk module 120 sends a serial general purpose input/output. (SGPIO) signal, when a read/write action occurs therein. Since the signal sending is conventional, and thus omitted here for clarity.

The indicator light control circuit 130 comprises a register 131 and a control unit 132. The register 131 is preset with a storage space of fixed bits. Each of the fixed bits in the register has an initial data of zero value. Whenever there is a level change on the SGPIO signal (i.e. high to low; low to high), the register 131 writes a bit of effective non-zero data into the storage space, such as value “1”. In real implementation, the bit number is generated by calculating a frequency of the SGPIO port and a human recognizable frequency. For example,

Since the SGPIO port has a frequency of 1.56 kHz, and a blink frequency recognizable by human eyes is approximately “10 Hz”, which corresponds to a period of “104/10 seconds”, which may be doubled, i.e. 20 Hz when an Alternative Mark Inversion (AMI) manner is used. “20 Hz” corresponds to a period of “50 ms”. In the period of “50 ms”, the frequency “1.56 kHz” has its effective data bits of “1560/20=78”. To facilitate a hexadecimal representation, a null data of 2 bits may be added, and thus the register 131 has its storage space of 80 bits, i.e. the register 131 is an 80-bit register. In addition, whenever the SGPIO signal has a level change, the register 131 writes the effective non-zero data into a lowest bit of the storage space, and all the bits in the register 131 is shifted by one bit towards a highest bit before the write action.

Namely, for every predetermined period, as long as there is a data read/write, the storage space in the register 131 has no chance of being all zero. At this time, a high level may be outputted to extinguish the read/write indicator light 110 so that a data read/write is indicated. And, now matter how large a read/write frequency, the read/write indicator light 110 will extinguish at the end of the fixed time period. Then, in a next fixed time period, now matter if there is a data read/write action, the outputted level will get inversed, i.e. maintain at a high level “50 ms”.

As to the control unit 132, it checks out a content of the register 131 once every a predetermined period. When the data in the bits in the register 131 is not all zero value, a drive signal is outputted to drive the read/write indicator light 110 to blink. It is to be particularly pointed out that the indicator light control circuit 130 may, in real implementation, further receive a frequency threshold, such as “10 Hz”. Further, the frequency of the SGPIO signal and frequency threshold value are relied upon to calculate the bit number of the register 131, to filter out any high frequency signal having a frequency higher than the frequency valve.

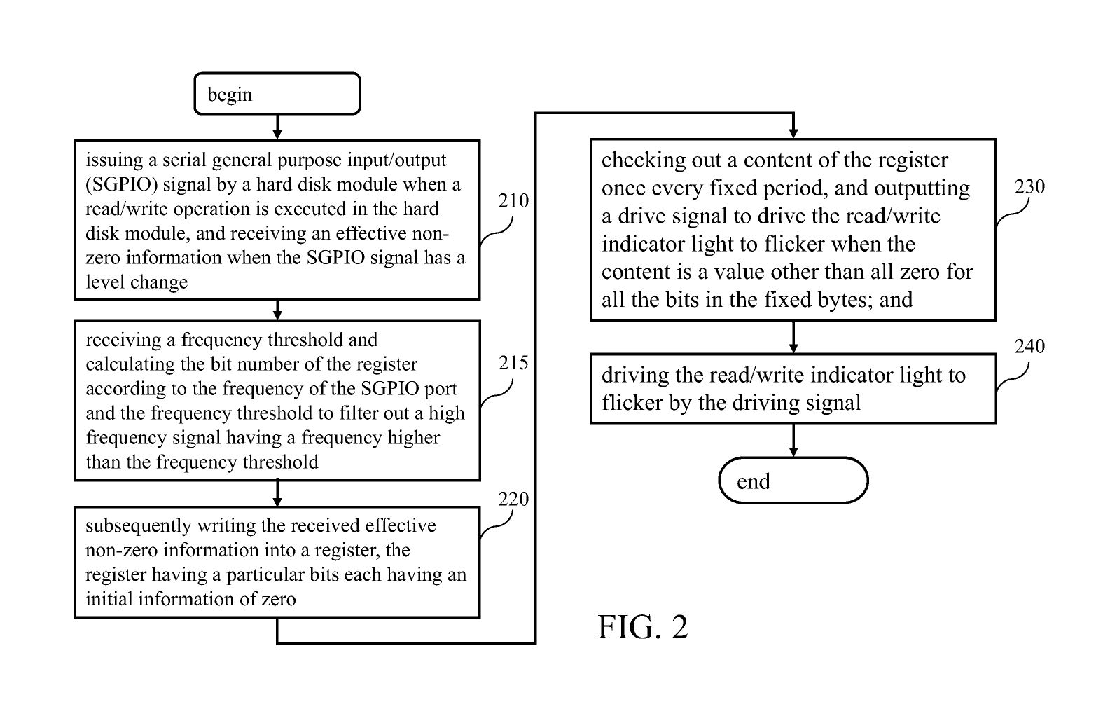

Thereafter, referring to FIG. 2, which is a control method for a read/write indicator light according to the present invention. The method comprises the following steps. When the a hard disk in the hard disk module 120 has a read/write action, the hard disk module 120 may send out the SPGIO signal, and an effective non-zero data is received when the SPGIO signal has a level change (S210). Subsequently, writing the received effective non-zero information into a register in order, in which each bit in the register 131 is all zero as its initial data (S220).

In every predetermined period, a content of the register 131 is checked out for once. When each bit in the register 131 is all a zero value, it is determined as no read/write action occurring, while a read/write action is occurring is determined. At this time, a drive signal is outputted (S230) to drive the read/write indicator light to blink (S240).

By means of the above steps, a SGPIO signal is issued when a read/write action occurs, a bit of effective non-zero data is written into the register 131 when the SGPIO signal has a level change, a content of the register is checked out every predetermined period, and a drive signal is outputted to drive the read/write indicator light 110 to blink when the data in every bit of the register 131 is not all non-zero.

It is to be particularly pointed out that there may be also a step of receiving a frequency threshold value, calculating the bit number of the register 131 according to the frequency of the SGPIO signal and the mentioned frequency threshold value, so as to filter out the high frequency signal having its frequency larger than the frequency threshold, such as “10 Hz”.

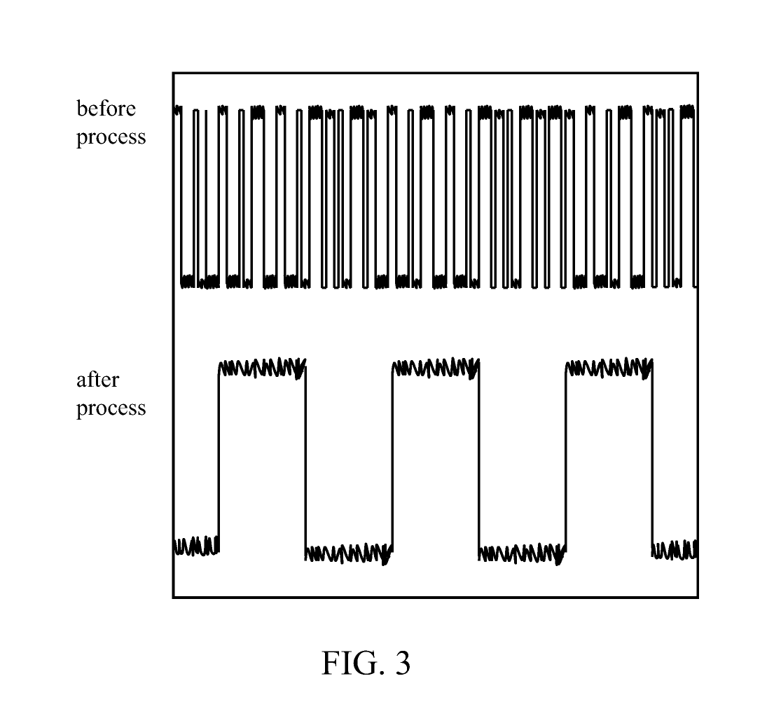

In the following, an embodiment is set forth with reference to FIG. 3 for description. FIG. 3 is a schematic diagram for illustrating controlling the read/write indicator light by using a drive signal according to the present invention. In real implementation, when the hard disk in the hard disk module 120 has a read/write action, the hard disk module 120 may issue the SGPIO signal, as is schematically shown in FIG. 3 in a prior-processing waveform. This is quite contrary to the case in the prior art where the signal is used to directly drive the read/write indicator light 110 without any processing.

Therefore, when the waveform frequency goes beyond a frequency recognizable to human eyes, a user is difficult to recognize if there is a read/write action occurring on the hard disk. In view of this, the present invention does not drive the read/write indicator light 110 directly by using the SGPIO signal. Instead, the register 131 of the indicator light control circuit 130 writes one bit of effective non-zero data into the storage space of preset fixed bits whenever the SGPIO signal has a level change, i.e. high to low level, or low to high level.

Thereafter, the control unit 132 checks out the content of the register 131, i.e. the data in the storage space once every predetermined period. When the data in each bit of the register is not all zero values, it is indicated that there is a read/write action in this period. Thus, a drive signal is outputted to drive the read/write indicator light 110 to blink, where the drive signal is illustrated as the post-processed waveform. It may be known that even the read/write action occurs over than once every predetermined period, the read/write indicator light only blink for once. Since the predetermined period is recognizable to human eyes, there is no the chance that the human eyes may not recognize.

The system and method of the present invention has the difference that a serial general purpose input/output signal is issued when a read/write action occurs, a bit of effective non-zero data is written into a register when the SGPIO signal has a level change, a content of the register is checked out every predetermined period, and a drive signal is outputted to drive the read/write indicator light to blink when the data in every bit of the register is not all non-zero, whereby the technical efficacy of promoting the recognizability of read/write indicator light may be achieved.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A server system, comprising:
at least a read/write indicator light;
at least a hard disk module, generating a serial general purpose input/output (SGPIO) signal when a read/write operation is executed therein; and
an indicator control circuit, comprising:
a register, having a size of a fixed bits each being set to a zero value at the beginning of every a predetermined period, and being written with a non-zero value to one of the fixed bits when the level of SGPIO signal thereof is changed; and
a control unit, checking each of the fixed bits in the register once every predetermined period, and outputting a drive signal to drive the read/write indicator light to blink when any of the bit value is nonzero.

2. The server system as claimed in claim 1, wherein a number of the fixed bits in the register is calculated according to a frequency of the SGPIO signal and a human eye distinguishable frequency.

3. The server system as claimed in claim 2, wherein the size of the register is 80 bits, including 78 data bits and 2 non-data bits.

4. The server system as claimed in claim 1, wherein the register shifts each of the fixed bits to a higher order bit by one bit among all the fixed bits and then writes the non-zero value into a lowest order bit of the register when the level of SGPIO signal thereof is changed.

5. The server system as claimed in claim 1, wherein the indicator light control circuit further receives a threshold and calculates the number of bits of the register according to the frequency of the SGPIO signal and the threshold to filter out a high frequency signal having a frequency higher than the threshold.

6. A control method for a read/write indicator light, comprising steps of:
issuing a serial general purpose input/output (SGPIO) signal by a hard disk module when a read/write operation is executed in the hard disk module, and receiving an effective non-zero information when the SGPIO signal has a level change occurring;
subsequently writing the received effective non-zero information into a register, the register having a fixed bits each having an initial value of zero;
checking out a content of the register once every predetermined period, and outputting a drive signal to drive the read/write indicator light to blink when the content is a value other than all zero for all the fixed bits; and
driving the read/write indicator light to blink by the driving signal.

7. The control method as claimed in claim 6, wherein a number of the fixed bits of the register is generated according to a frequency of a SGPIO port and a human eye recognizable frequency.

8. The control method as claimed in claim 7, wherein the register has a storage space of 80 bits, including the effective information of 78 bits and a null information of 2 bits.

9. The control method as claimed in claim 6, wherein the register shifts each of the fixed bits to a higher order bit by one bit among all the fixed bits and then writes the non-zero value into a lowest order bit of the register when the level of SGPIO signal thereof is changed.

10. The control method as claimed in claim 6, further comprising a step of the indicator light control circuit further receives a threshold and calculates the number of bits of the register according to the frequency of the SGPIO signal and the threshold to filter out a high frequency signal having a frequency higher than the threshold.
